(19) United States
(12) Patent Application Publication
(10) Pub. No.: US 2013/0085619 A1
(43) Pub. Date: Apr. 4, 2013

(54) METHODS AND SYSTEMS FOR REMOTE CONTROLLING OF IRRIGATION SYSTEMS

(71) Applicant: Cory Howard, Grapevine, TX (US)

(72) Inventor: Cory Howard, Grapevine, TX (US)

(21) Appl. No.: 13/252,208

(22) Filed: Oct. 4, 2011

(51) Int. Cl. G05D 7/06

(52) U.S. Cl. 700/284

(57) ABSTRACT

A computer-implemented methods and systems for remote controlling of irrigation are provided. The method may comprise: monitoring one or more sensor measurement parameters per irrigation zone; determining whether the one or more sensor measurement parameters exceed predetermined values for each irrigation zone; selectively irrigating one or more irrigation zones; recording the monitored sensor measurement parameters to a database; and serving at least one web page configured to enable users to review the recorded sensor measurement parameters per irrigation zone and change the predetermined values related to the one or more sensor measurement parameters for the one or more irrigation zones.

### TECHNICAL FIELD

This disclosure relates generally to data processing, and more particularly to methods and systems for remote controlling electronic devices related to an irrigation system.

### DESCRIPTION OF RELATED ART

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Irrigation is a way of delivering water to the land or soil. It is used to assist in growing agricultural crops, maintaining landscapes, and revegetating disturbed soils in dry areas and during periods of inadequate rainfall. Additionally, the irrigation can also help in protecting plants against frost, suppressing weed growing in grain fields and preventing soil consolidation.

Today, automated irrigation systems are widely used to control the irrigation of yards, sport fields, lawns, etc. Such systems are typically comprise a bunch of watering devices, e.g. sprinklers or driplines, coupled to a pipeline, one or more solenoid valves, and a controller. The pipeline can be coupled to a water main or a water pump. Conventionally, the controller is used to control the solenoid valves for water supply through sprinklers or driplines in specific zones. The controller can be located remotely, e.g. in premises, and embed a program to control watering in due times. The controller program can be accessed and changed by users through a user interface. Typically, the users establish a virtual schedule via the user interface to define specific times when the irrigation system should be activated. For example, the irrigation system can be programmed by the users to be activated each day at 7.00 p.m. during 10 minutes.

Most irrigation systems are arranged in such a way that the controller and the user interface are located at premises and the users may manipulate them locally. This approach is inconvenient and lacks flexibility. However, in recent years, the controller can be coupled to a wide area network, such as the Internet, to enable the users to manipulate their irrigation systems remotely by utilizing a browser-equipped client like a laptop or smart phone. This approach provides sufficient flexibility, especially for those who are limited in time or who travel.

When installed and programmed properly, i.e. when a schedule is established, the automated irrigation systems can provide watering to landscapes or soils on a regular basis so that they are kept in conditions of optimal humidity. However, it is not the case for most users. Indeed, it is very difficult for non-professionals to establish right parameters for the virtual schedule, i.e. set activation times and a necessary amount of water that should be delivered daily to their lawns or yards.

As a result, even if an automated irrigation system is installed, the soils can struggle either from over-watering or, vice versa, the lack of necessary watering. In the first case, the way of spending water is costly and ineffective. Moreover, the over-watering may promote weakening of premises foundations or other facilities. In the latter case, when the watering is insufficient, the soils may not comprise enough moisture, and plants can be damaged. Furthermore, premises foundation can be significantly damaged when soils are constrict or moved leading to costly defects.

It should be also mentioned that even when the schedule is programmed properly, weather conditions, such as temperature, rainfalls, air humidity, and the like, may be changed dramatically from month to month. Accordingly, the properly programmed schedule should be refined on a regular basis to meet the conditions of changing weather. This approach is inconvenient and ineffective.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In accordance with various embodiments and the corresponding disclosure thereof, a computer-implemented method for remote controlling of irrigation is provided. The method may comprise: monitoring one or more sensor measurement parameters per irrigation zone; determining whether the one or more sensor measurement parameters exceed predetermined values for each irrigation zone; selectively irrigating one or more irrigation zones; recording the monitored sensor measurement parameters to a database; and serving at least one web page configured to enable users to review the recorded sensor measurement parameters per irrigation zone and change the predetermined values related to the one or more sensor measurement parameters for the one or more irrigation zones.

In one example, the selective irrigation of the one or more irrigation zones may comprise selectively activating at least one irrigation device to water the one or more irrigation zones. The selective irrigation of the one or more irrigation zones may comprise selectively opening at least one water valve to water the one or more irrigation zones. The method may further comprise selectively closing one or more water valves related to an irrigation zone when corresponding one or more of the one or more sensor measurement parameters become below the predetermined values.

The monitoring of the one or more sensor measurement parameters may be performed in real time. The monitoring of the one or more sensor measurement parameters is scheduled in time. The monitoring can also be scheduled in time. The sensor measurement parameters may comprise one or more of: relative humidity, humidity, moisture, a flow speed, a water pressure, a temperature, a frequency, and a voltage. The method may further comprise connecting to the irrigation system over a network. The method may further comprise determining a defect in the irrigation system responsive to matching the one or more sensor measurement parameters to the predetermined values and reporting data related to the defect to a user.

The method may further comprise receiving a user comand to compulsorily open or close the one or more water valves, and opening or closing the one or more water valves responsive to the user comand. The method may further comprise receiving user credentials to access the web page, and authorizing the user to access the web page based on the received user credentials such that authorized users only are enabled to data interchange with the web site.

According to other various embodiments, a system and a computer-readable medium having computer instructions stored thereon to implement the above described methods are also provided.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 shows a block diagram illustrating a system environment suitable for remote controlling of irrigation process according to an example embodiment.

FIG. 2 is a representation of an irrigation system according to an example embodiment.

FIG. 3 is a diagram of an irrigation area separated into zones according to an example embodiment.

FIG. 4 is a diagram of the system for remote controlling of irrigation according to an example embodiment.

FIG. 5 is a process flow diagram showing a method for remote controlling of irrigation according to an example embodiment.

FIG. 6 is a process flow diagram showing a method for remote controlling of irrigation according to another example embodiment.

FIG. 7 is a diagrammatic representation of an example machine in the form of a computer system within which a set of instructions, for the machine to perform any one or more of the methodologies discussed herein, is executed.

### DETAILED DESCRIPTION

The following detailed description includes references to the accompanying drawings, which form a part of the detailed description. The drawings show illustrations in accordance with example embodiments. These example embodiments, which are also referred to herein as “examples” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

In accordance with various embodiments and the corresponding disclosure thereof methods and systems for remote controlling of irrigation are provided. These methods are directed to change the ineffective prior art schedule-based approaches for automated irrigation as currently widely utilized to the intelligent irrigation approach which aims to control current conditions of soils to determine whether the soils are in need to be watered and, if so, in what time and in what amount.

The proposed approach may be implemented in a client-server environment and comprise a local irrigation system and a network server which may communicate with each other over a network, such as the Internet. The irrigation system may comprise a distributed set of irrigation devices (e.g., sprinklers or driplines) to be installed in multiple zones of a yard, a field, a landscape, etc. The irrigation devices are connected to a watermain via a set of electronic (solenoid) valves such that the watering of each zone may be controlled by a separate valve. The irrigation system may also comprise a set of sensors which can be installed in each irrigation zone. These sensors may include, but not limited to, humidity sensors, relative humidity sensors, moisture sensors, temperature sensors, pressure sensors, water speed sensors, voltage sensors. The irrigation system may also comprise a controller to take control over the set of sensors and the set of valves. More specifically, the controller may obtain measured parameters from each installed sensor in real time on an ongoing basis and also control the valves to open or close them. The controller can be in communication with a remote server. The remote server, in turn, may be a web server and host a web site. The remote server may embed an irrigation program which is directed to obtain sensor measurement parameters from the controller and match them to predetermined values. When the sensor measurement parameters exceed such predetermined values, the server may instruct the controller to selectively activate certain valves to irrigate certain zones with a certain amount of water. The server may also host a web site which can be accessed with authorized users to review current or past measurement parameters and make changes in the predetermined values or the irrigation program. Accordingly, users may install the irrigation system and manage the irrigation process over the Internet from any suitable place which is convenient especially when users travel.

According to multiple embodiments disclosed herein, the irrigation system may work as follows. The server may be configured to monitor multiple sensor parameters which can be obtained from the controller. The monitoring is performed in real time or each certain period of time not to jeopardize data traffic. Each time parameters are acquired, the server may determine whether the one or more parameters exceed predetermined values for each irrigation zone. If so, the server may instruct the controller to selectively irrigate one or more irrigation zones. The irrigation may be performed during a predetermined amount of time, or until the corresponding parameters are in the predetermined limits. The server may also record the monitored parameters to a database, which can be a part of the server or be remotely located. As mentioned, the server may also serve web pages configured to enable users to review the recorded parameters per irrigation zone and change the predetermined values and value limits related to the parameters for all irrigation zones.

Provided below is a detailed description of certain embodiments. In this document, the terms “a” or “an” are used, as is common in patent documents, to include one or more than one. In this document, the term “or” is used to refer to a nonexclusive “or”, such that “A or B” includes “A but not B”, “B but not A”, and “A and B”, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The embodiments described herein can be implemented by various means, depending on application. For example, the embodiments can be implemented in hardware, firmware, software, or a combination thereof. For hardware implementation, the embodiments can be implemented with processors, controllers, micro-controllers, microprocessors, electronic devices, other electronic units designed to perform the functions described herein, or a combination thereof. Memory can be implemented within a processor or external to the processor. As used herein, the term “memory” refers to any type of long term, short term, volatile, nonvolatile, or other storage device and is not to be limited to any particular type of memory or number of memories, or type of media upon which memory is stored. For firmware and/or software implementation, the embodiments can be implemented with modules such as procedures, functions, and so on, that perform the functions described herein. Any machine readable medium tangibly embodying instructions can be used in implementing the embodiments described herein.

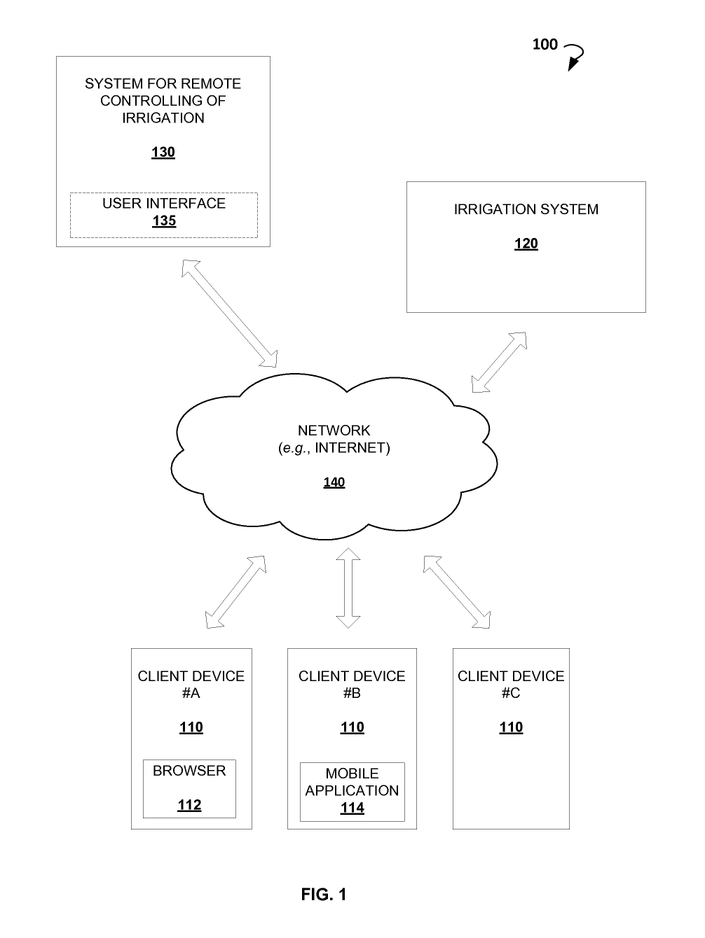

Referring now to the drawings, FIG. 1 shows a block diagram illustrating a system environment 100 suitable for remote controlling of irrigation process according to an example embodiment. The system environment 100 comprises one or more client devices 110, an irrigation system 120, a system 130 for remote controlling of irrigation, and a network 140.

The network 140 may couple one or more of the aforementioned modules. The network 140 is a network of data processing nodes interconnected for the purpose of data communication, which may be utilized to communicatively couple various components of the environment 100. The network 140 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34b is analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 120 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The client devices 110 may refer to a computer, a laptop, a tablet computer, a portable computing device, a personal digital assistant (PDA), a handheld cellular phone, a mobile phone, a smart phone, a wireless telephone, a handheld device having wireless connection capability, or any other electronic device with the ability to receive and transmit data via the wire or wireless network 140 (e.g., with the ability to browse the Internet).

The client devices 110 can be used to communicate with the system 130 for remote controlling of irrigation relating to one or more areas associated with users of the client devices 110. As will be further described, the users may communicate with the system 130 for remote controlling of irrigation to review current conditions of the controlled areas/zones, compulsorily activate one or more irrigation devices, and set or change irrigation program settings. To accomplish this means, the user may utilize a browser 112 of the client device 110 and the system 130 for remote controlling of irrigation may include a user interface 135 accessible via the browser 112. The browser 112 may provide the ability to browse and interact with sites on the Internet including the site deployed within the system 130 or any other site, e.g. any affiliated web site.

In some other embodiments, the client device 110 may comprise software to communicate with the system 130 for remote controlling of irrigation. In one example, the software is a mobile application 114 embedded in the client device 110. The mobile application 114 may embed multiple modules and databases.

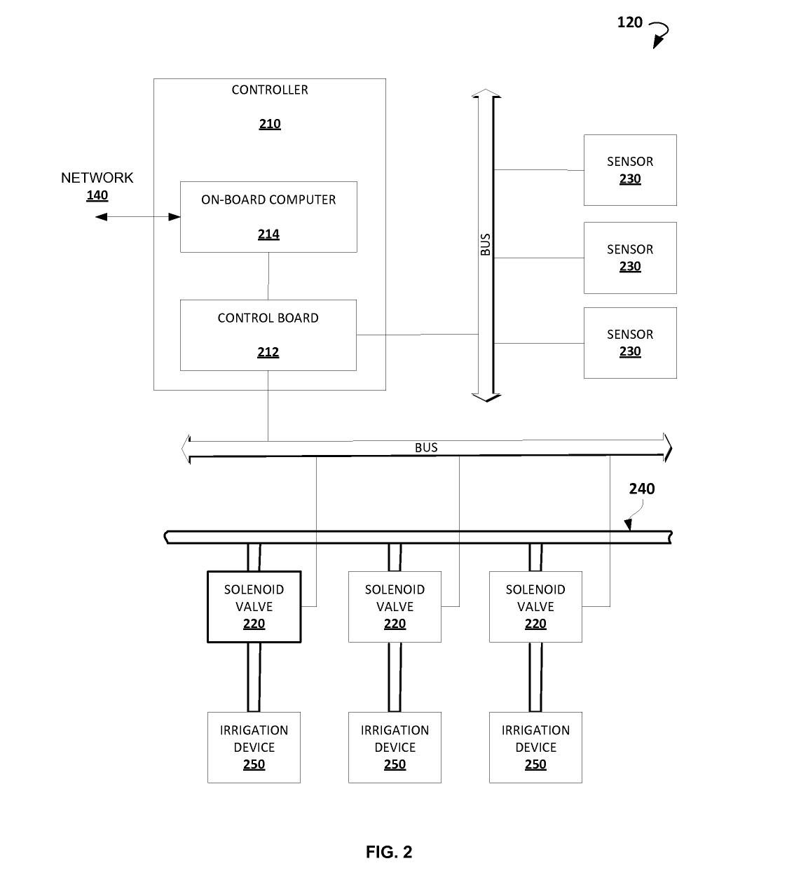

The irrigation system 120, according to various embodiments disclosed herein, may be installed at the area to be irrigated. The irrigation system 120 may comprise a controller (not shown) coupling a set of different sensors and solenoid valves. The irrigation system 120 may be coupled to the network 140 to communicated with the system 130 for remote controlling of irrigation. The irrigation system 120 will be further described below with reference to FIG. 2.

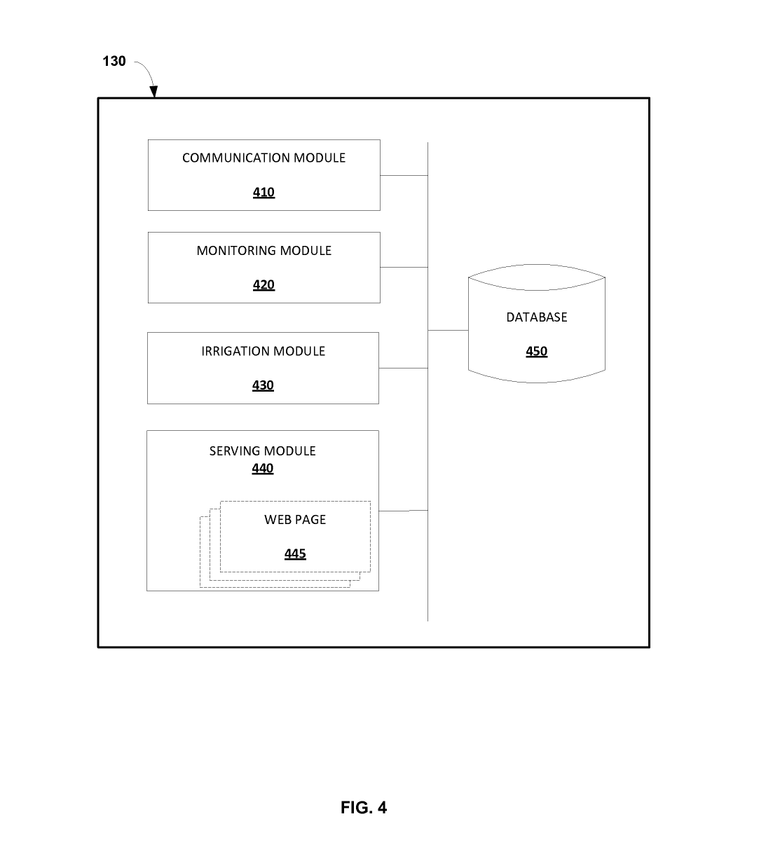

The system 130 for remote controlling of irrigation can be implemented as a remote server having multiple embeded modules and databases. The system 130 for remote controlling of irrigation may communicate with the one or more client devices 110 and the irrigation system 120. The system 130 for remote controlling of irrigation is described in more detail below with reference to FIG. 4.

FIG. 2 is a representation of the irrigation system 120 according to an example embodiment. In this embodiment, the irrigation system 120 may include a controller 210, a set of electronic (solenoid) valves 220, and a set of sensors 230. In other embodiments, the irrigation system 120 may include additional, fewer, or different modules for various applications.

The controller 210 may be configured as hardware which may embed software or firmware. The controller 210 may be configured to acquire parameters measured by the sensors 230 and selectively controll the set of solenoid valves 220. The controller 210 may further be configured to communicate with the system 130 for remote controlling of irrigation over the network 140. In particular, the controller may transmit acquired parameters measured by the sensors 230 to the system 130. The controller 210 may also receive instructions to activate or deactivate (i.e., open or close) certain or all solenoid valves 220.

In one exemplary embodiment, the controller 210 may comprise, among other things, a control board 212 and an on-board computer 214. The control board 212 may communicatively couple the sensors 230 and/or solenoid valves 220 to the controller 210, and serve as a ‘hub’ to expand a single port of the on-board computer 214 so that multiple sensors 230 and/or solenoid valves 220 are connected to the on-board computer 214. The on-board computer 214 in turn may be any computing device having the ability to process data and communicate with other devices, such as the system 130 for remote controlling of irrigation. In one example, the on-board computer 214 is a non-monitor ‘mini-computer’ having multiple software modules embedded thereon.

The solenoid valves 220 are electromechanical valves coupled to distributed water pipes or watermain 240. The solenoid valves 220 can be activated by the controller 210 to provide water to certain irrigation devices 250.

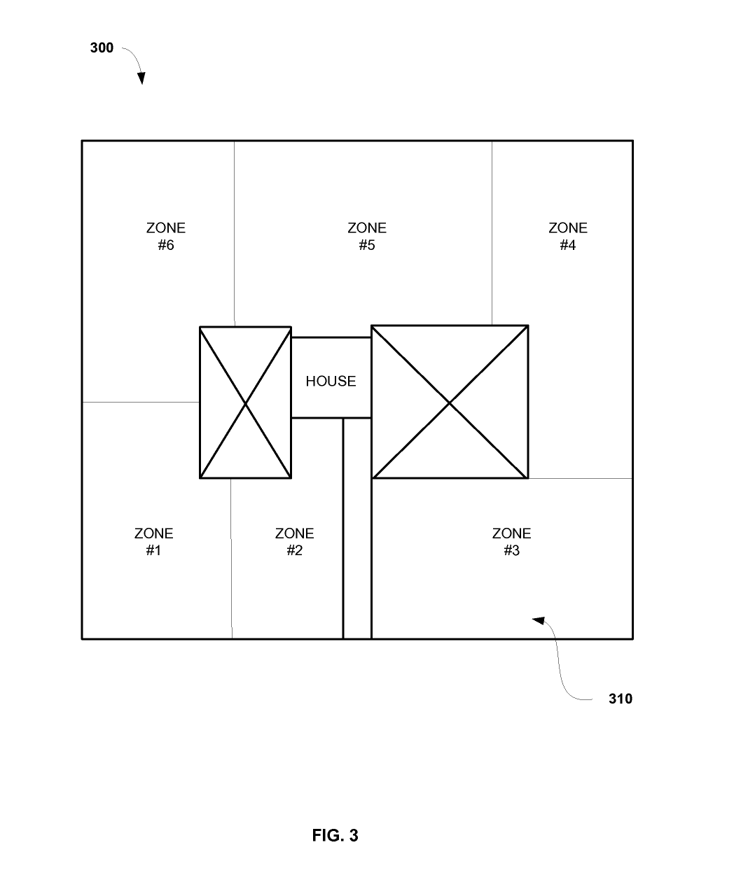

The irrigation devices 250 may comprise splinkers, driplines or any other device to deliver water to soils. The solenoid valves 220 and the irrigation devices 250 can be distributed over an irrigated area in such a way that the area is divided into certain zones. Accordingly, each zone can be irrigated separately. In one example, a yard can be separated into multiple zones as shown in FIG. 3. In some embodiments, the irrigation devices 250 may be integrated with the solenoid valves 220.

The sensors 230 may comprise one or more of: a relative humidity sensor, a humidity sensor, a moisture sensor, a flow speed sensor, a water pressure sensor, a temperature sensor, a rain sensor, a frequency sensor, and a voltage sensor. Some sensors 230 (e.g., humidity or moisture sensors) may be installed on the surface or buried in the ground in the targeted locations. Other sensors 230, i.e. the flow speed sensor or the water pressure sensor may be installed in the water pipe 240 to detect a leakage or a clog, or to controll amount of water provided for irrigation. As shown in FIG. 3, each zone can be provided with one or more sensors to control the soil conditions separately.

The irrigation system 120 may also comprise relays (not shown) for controlling the valves 220. The irrigation system 120 may comprise include additional, fewer, or different modules for various applications.

FIG. 3 is a diagram of an irrigation area 300 separated into zones 310 according to an example embodiment. Such diagram can be virtually presented to the users via the client devices 110 when they access the system 130 for remote controlling of irrigation. In the shown example, a private yard is divided into 6 irrigation zones 310 which can be watered independently.

FIG. 4 is a diagram of the system 130 for remote controlling of irrigation according to an example embodiment. In this embodiment, the system 130 may comprise a communication module 410, a monitoring module 420, an irrigation module 430, a serving module 440, and a database 450. In other embodiments, the system 130 may include additional, fewer, or different modules for various applications. Said modules can be implemented as hardware and/or software. Furthermore, all modules can be integrated within a single apparatus, or, alternatively, can be remotely located and optionally be accessed via a third party.

The communication module 410 can be configured to communicatively couple the system 130 for remote controlling of irrigation and the client devices 110 via the network 140. The connection and data transfer may be provided via one or more Application Programming Interfaces (APIs).

In certain embodiments, the communication module 410 can be configured to receive and process parameters measured by the sensors 230. As mentioned, the parameters may include relative humidity, humidity, moisture, a flow speed, a water pressure, a temperature, a frequency, and a voltage. The communication module 410 can also be configured to receive and process user requests to access web pages, obtain current sensor parameters, selectively activate or deactivate certain valves 220, establish or change irrigation program parameters, establish an irrigation schedule, and so forth.

The communication module 410 can also be configured to instruct said one or more solenoid valves 220 to start or stop irrigation (i.e., instructions to start or stop watering), transmit data to the client devices 110, provide access to the web pages, and so forth. In one example, the communication module 410 may establish connection using TCP/IP suite.

The monitoring module 420 can be configured to acquire and monitor parameters measured by the sensors 230. The monitoring can be performed on a real time basis. The monitoring module 420 can further be configured to record the monitored parameters to the database 450. In order not to jeopardize a network bandwidth, the acquiring and/or recording of parameters can be performed each period of time, such as each 10, 30, 60 minutes, or alike.

Furthermore, the monitoring module 420 can be configured to determine whether the one or more acquired parameters exceed predetermined values for each irrigation zone. The predetermined values may be preset by the users and stored in the database 450. Some other intelligent algorithms can also be applied.

The irrigation module 430 can be configured to selectively irrigate one or more irrigation zones. More specifically, the irrigation module 430 can selectively activate or deactivate at least one solenoid valve 220 to water one or more irrigation zones or their parts. The watering can be conducted either for a certain amount of time, or until corresponding one or more sensor measurement parameters become below the predetermined values.

The serving module 440 can be configured to serve at least one web page to enable users to review the recorded sensor measurement parameters per irrigation zone and change the predetermined values related to one or more sensor measurement parameters for the one or more irrigation zones.

Furthermore, the serving module 440 can be configured to host one or more web pages 445 directed to provide, among other things, the functionality to establish and manage user profiles, manage irrigation settings, review current sensor parameters, and selectively activate or deactivate an irrigation process, and so forth.

According to various embodiments, when the irrigation is installed, the web page 445 is created to provide the above-mentioned functionality. The web page 445 may contain one or more fields or widgets that can be modified or reviewed by users via their client devices 110. The users may optionally generate member profiles. If this is the case, the membership details may be stored in the database 450. The membership profile stored may comprise information on an irrigation area and its zones, user information, user credentials, or any other information. When users try to access the web page 445, they may be requested to provide the user credentials, such as a login and a password for authentication purposes. According to some embodiments, only authorized users are enabled to data interchange with the web page 445.

The database 450 may store irrigation programs, irrigation program settings, measured parameters, information related to irrigation areas and zones, membership profiles, and so forth.

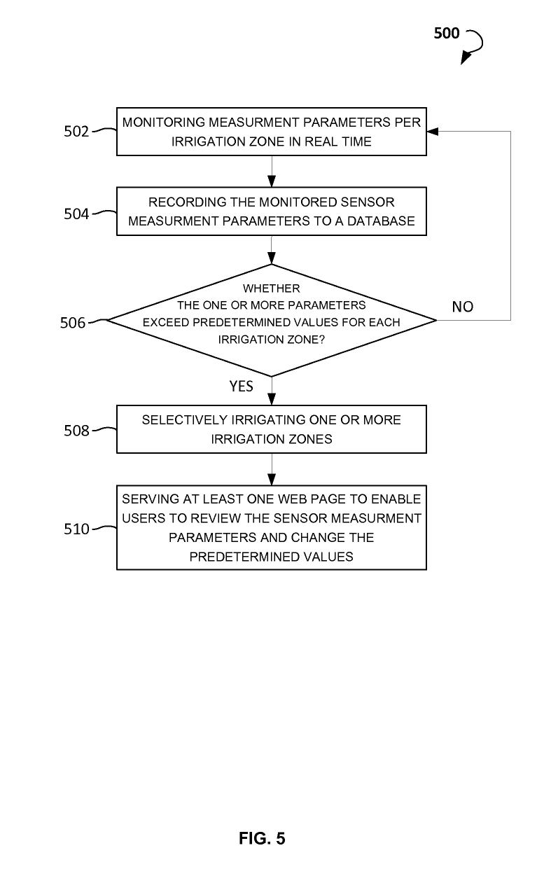

FIG. 5 is a process flow diagram showing a method 500 for remote controlling of irrigation according to an example embodiment.

The method 500 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the system 130 for remote controlling of irrigation and the method 500 can be performed by the various modules of the system 130. Each of these modules can comprise processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of various steps described herein, fewer or more modules may be provided and still fall within the scope of various embodiments.

As shown in FIG. 5, the method 500 may commence at operation 502 with the monitoring module 420 monitoring one or more sensor measurement parameters per irrigation zone in real time. The monitoring can include requesting and/or acquiring sensor measurement parameters per time interval. At operation 504, the monitoring module 420 can record the monitored sensor measurement parameters to the database 450.

The method 500 further proceeds to operation 506, when the monitoring module 420 determines whether the one or more sensor measurement parameters exceed predetermined values for each irrigation zone. The predetermined values can be stored in the database 450.

In one example, if the one or more sensor measurement parameters are within predetermined limits, the method 500 proceeds to operation 502. Alternatively, when it is determined that the one or more sensor measurement parameters exceed the predetermined values, the method 500 proceeds to operation 508 when the irrigation module 430 selectively irrigate corresponding irrigation zones per measurement parameters and the irrigation program.

At operation 510, the service module 440 serves at least one web page 445 configured to enable users to review the recorded sensor measurement parameters per irrigation zone and change the predetermined values related to one or more sensor measurement parameters for one or more irrigation zones.

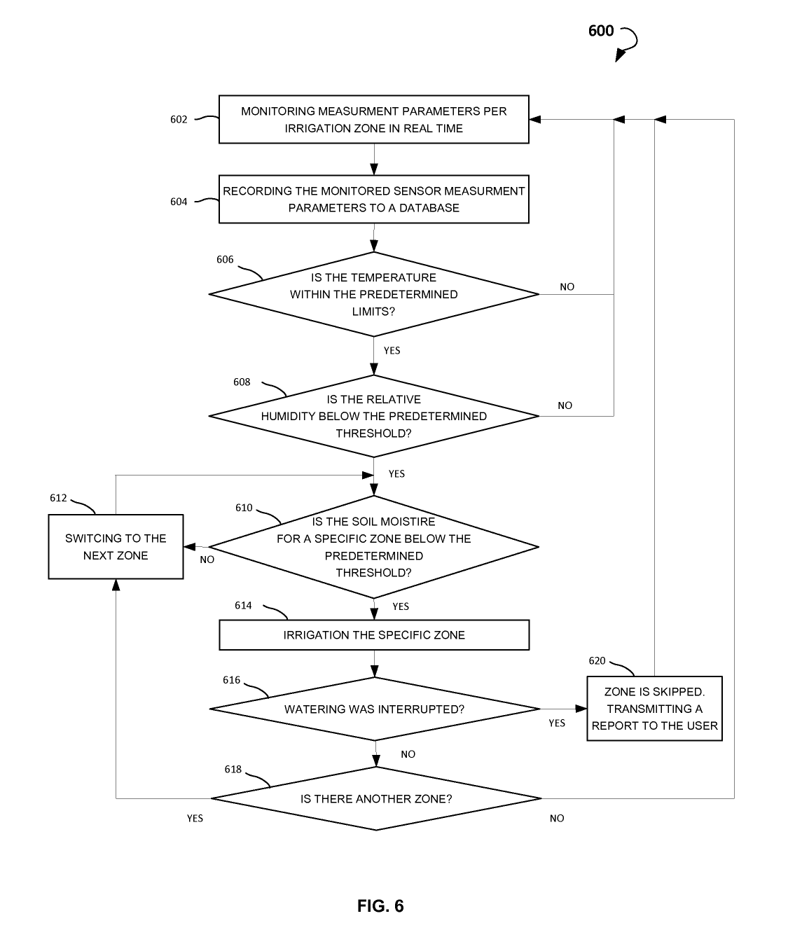

FIG. 6 is a process flow diagram showing a method 600 for remote controlling of irrigation according to another example embodiment.

The method 600 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the system 130 for remote controlling of irrigation and the method 600 can be performed by the various modules of the system 130. Each of these modules can comprise processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of various steps described herein, fewer or more modules may be provided and still fall within the scope of various embodiments.

The method 600 may commence at operation 602 with the monitoring module 420 monitoring sensor measurement parameters, such as a temperature, relative humidity, and moisture per irrigation zone. The monitoring can include requesting and/or acquiring sensor measurement parameters per time interval. At operation 604, the monitoring module 420 can record the monitored sensor measurement parameters to the database 450.

The method 600 further proceeds to operation 606, when the monitoring module 420 determines whether the temperature is between predetermined high and low thresholds. If the temperature is out of the predetermined limits, the method 600 proceeds back to operation 602. Alternatively, when it is determined that the temperature exceeds the predetermined values for the specific zone, the method 600 proceeds to operation 608 when it is determined whether the relative humidity is below the predetermined threshold. If not, the method 600 returns back to operation 602 of monitoring parameters. Alternatively, when it is determined that the relative humidity is below the predetermined threshold, the method 600 proceeds to operation 610 to determine whether soil moisture for a certain zone is below the predetermined threshold.

When the soil moisture for the certain zone is not below the predetermined threshold, the method 600 proceeds to operation 612 to switch to the next zone, and performs the determination operation 610 once again. Alternatively, when the measured soil moisture for the certain zone is below the predetermined threshold, the method 600 proceeds to operation 614 when a corresponding solenoid valve 220 is opened for a scheduled period of time to water the selected zone.

At operation 616, it is determined whether or not the watering was interrupted. In other words, it is determined whether the water pipes or other facilities are in a good condition, i.e. they are not leaked or clogged. If the watering was delivered in the prescribed amount, the method 600 proceeds to operation 618 when it is determined whether there is another zone to water. Alternatively, when watering was interrupted, the method 600 proceeds to operation 620 to skip this zone and generate an alarm (an e-mail, a SMS, a MMS for the user to report problems with the irrigation system), and then to operation 612.

When at operation 618 it is determined that there is another zone to water, the method 600 proceeds back to operation 612. Alternatively, the method 600 proceeds back to operation 602.

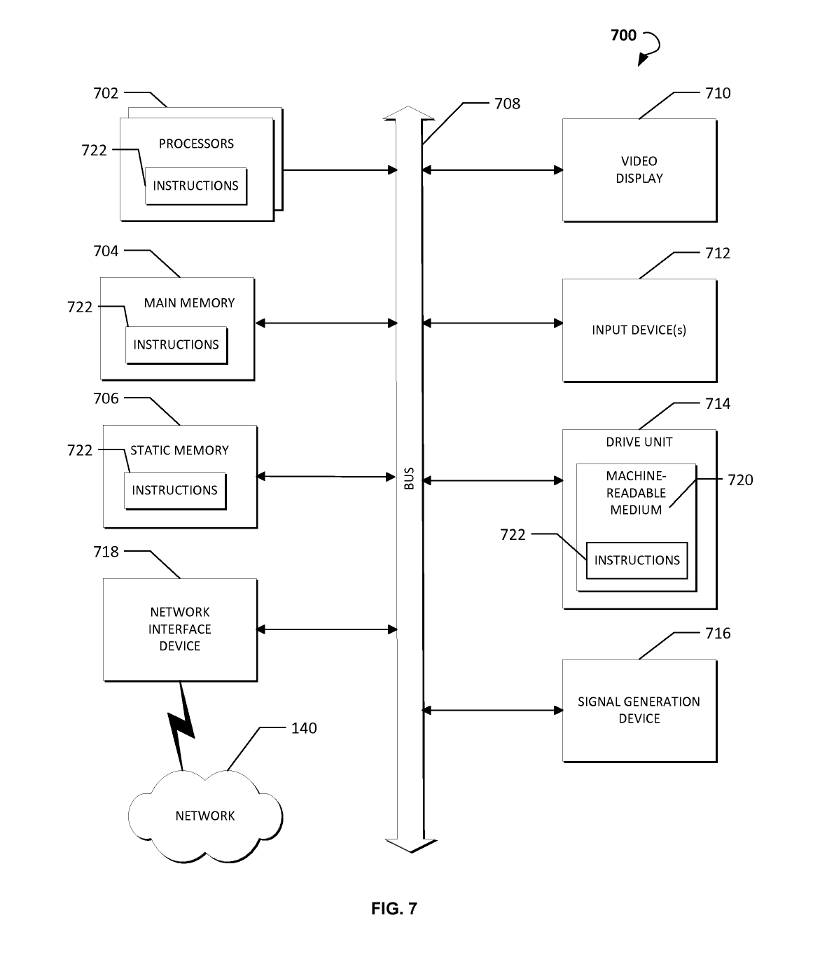

FIG. 7 shows a diagrammatic representation of a computing device for a machine in the example electronic form of a computer system 700, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702 (e.g., a central processing unit (CPU), a graphics processing unit (GPU), or both), and a main memory 704 and a static memory 706, which communicate with each other via a bus 708. The computer system 700 can further include a video display unit 710 (e.g., a liquid crystal displays (LCD) or a cathode ray tube (CRT)). The computer system 700 also includes at least one input device 712, such as an alphanumeric input device (e.g., a keyboard), a cursor control device (e.g., a mouse), a microphone, and so forth. The computer system 700 also includes a disk drive unit 714, a signal generation device 716 (e.g., a speaker), and a network interface device 718.

The disk drive unit 714 includes a computer-readable medium 720 which stores one or more sets of instructions and data structures (e.g., instructions 722) embodying or utilized by any one or more of the methodologies or functions described herein. The instructions 722 can also reside, completely or at least partially, within the main memory 704 and/or within the engines 702 during execution thereof by the computer system 700. The main memory 704 and the engines 702 also constitute machine-readable media.

The instructions 722 can further be transmitted or received over the network 140 via the network interface device 718 utilizing any one of a number of well-known transfer protocols (e.g., Hyper Text Transfer Protocol (HTTP), CAN, Serial, and Modbus).

While the computer-readable medium 720 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAMs), read only memory (ROMs), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods and systems for remote controlling of an irrigation processes have been disclosed. These methods and systems are directed to provide irrigation based on current conditions of monitored soils rather than utilizing schedule-based systems known from the prior art. The proposed approach also allows users to monitor and controll the irrigation process remotely via the Internet.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method for remote controlling of irrigation, the method comprising:
monitoring one or more sensor measurement parameters per irrigation zone;
determining whether the one or more sensor measurement parameters exceed predetermined values for each irrigation zone;
selectively irrigating one or more irrigation zones;
recording the monitored sensor measurement parameters to a database; and
serving at least one web page configured to enable users to review the recorded sensor measurement parameters per irrigation zone and change the predetermined values related to the one or more sensor measurement parameters for the one or more irrigation zones.

2. The computer-implemented method of claim 1, wherein the selectively irrigating comprises selectively activating at least one irrigation device to water the one or more irrigation zones.

3. The computer-implemented method of claim 1, wherein the selectively irrigating comprises selectively opening at least one water valve to water the one or more irrigation zones.

4. The computer-implemented method of claim 3, further comprising:
selectively closing one or more water valves related to an irrigation zone when corresponding one or more of the sensor measurement parameters become below the predetermined values.

5. The computer-implemented method of claim 3, further comprising:
receiving a user comand to compulsorily open or close one or more water valves; and
opening or closing the one or more water valves responsive to the user comand.

6. The computer-implemented method of claim 1, wherein the monitoring is performed in real time.

7. The computer-implemented method of claim 1, wherein the monitoring is scheduled in time.

8. The computer-implemented method of claim 1, wherein the sensor measurement parameters comprise one or more of: relative humidity, humidity, moisture, a flow speed, a water pressure, a temperature, a frequency, and a voltage.

9. The computer-implemented method of claim 1, further comprising:
connecting to an irrigation system over a network.

10. The computer-implemented method of claim 9, further comprising:
determining a defect in the irrigation system responsive to matching the one or more sensor measurement parameters to the predetermined values; and
reporting data related to the defect to a user.

11. The computer-implemented method of claim 1, further comprising:
receiving user credentials to access the web page; and
authorizing a user to access the web page based on the received credentials such that only authorized users are enabled to data interchange with the web site.

12. A system for remote controlling of irrigation, the system comprising:
a monitoring module configured to monitor one or more sensor measurement parameters per irrigation zone in real time, record the monitored sensor measurement parameters to a database, and determine whether the one or more sensor measurement parameters exceed predetermined values for each irrigation zone;
an irrigation module configured to selectively irrigate one or more irrigation zones; and
a serving module configured to serve at least one web page to enable users to review the recorded sensor measurement parameters per irrigation zone and change the predetermined values related to the one or more sensor measurement parameters for the one or more irrigation zones.

13. The system of claim 12, wherein the irrigation module is further configured to selectively activate at least one irrigation device to water the one or more irrigation zones.

14. The system of claim 12, wherein the irrigation module is further configured to selectively open at least one water valve to water the one or more irrigation zones, and selectively close the one or more water valves when corresponding one or more of the one or more sensor measurement parameters become below the predetermined values.

15. The system of claim 12, further comprising:
a communication module configured to couple the system for remote controlling of irrigation to a network.

16. The system of claim 15, wherein the system for remote controlling of irrigation is coupled to an irrigation system over the network; and
wherein the irrigation system comprises:
one or more sensors selected from the group comprising: relative humidity sensor, humidity sensor, a moisture sensor, a flow speed sensor, a water pressure sensor, a temperature sensor, a frequency sensor, and a voltage sensor; and
a controller to control the one or more sensors, the controller being configured to communicate with the system for remote controlling of irrigation.

17. The system of claim 16, wherein the monitoring module is further configured to determine a defect in the irrigation system responsive to matching the one or more sensor measurement parameters to the predetermined values; and the communication module is further configured to report data related to the defect to a user.

18. The system of claim 15, wherein the communication module is further configured to receive a user comand to compulsorily open or close one or more water valves; and the irrigation module is further configured to open or close the one or more water valves responsive to the user comand.

19. A computer-readable medium having instructions stored thereon, which, when executed by one or more computers, cause the one or more computers to:
monitor one or more sensor measurement parameters per irrigation zone in real time;
determine whether the one or more sensor measurement parameters exceed predetermined values for each irrigation zone;
selectively irrigate one or more irrigation zones;
record the monitored sensor measurement parameters to a database; and
serve at least one web page configured to enable users to review the recorded sensor measurement parameters per irrigation zone and change the predetermined values related to the one or more sensor measurement parameters for the one or more irrigation zones.
